(19) United States
(12) Patent Application Publication
(10) Pub. No.: US 2025/0389290 A1
(43) Pub. Date: Dec. 25, 2025

(54) Fastening Assembly, and Part In Preassembly and Fastening System Including Same

(71) Applicant: Illinois Tool Works Inc., Glenview, IL (US)

(72) Inventor: Wenquan Sha, Shanghai (CN)

(21) Appl. No.: 19/243,435

(22) Filed: Jun. 19, 2025

(30) Foreign Application Priority Data
Jun. 19, 2024 (CN) 202410792619.4

(51) Int. Cl. F16B 5/02

(52) U.S. Cl. CPC F16B 5/0233; F16B 5/025

(57) ABSTRACT

The present disclosure provides a fastening assembly and a part in preassembly and a fastening system including same, the fastening assembly is configured to fasten a first component to a second component, the fastening assembly comprises a compensation element, a bolt and a washer. In the fastening assembly of the present disclosure, the washer and the compensation element can rotate together by adding a limiting structure on the washer. The washer is then prevented from rotating by abutting the bolt against the washer, thereby preventing the compensation element from rotating. Moreover, since the torque attenuation between the bolt made of a metal material and the washer made of a metal material is less than the torque attenuation between the washer made of a metal material and the compensation element made of a plastic material, so that it is less likely to cause the torque attenuation between the washer and the compensation element that rotate together. Therefore, the first component connected by means of the compensation element is also less likely to shake relative to the second component, making the connecting structure more robust and reliable.

### RELATED APPLICATION

The present application claims the benefit of Chinese Patent Application No. 202410792619.4, filed Jun. 19, 2024, titled “Fastening Assembly, and Part In Preassembly and Fastening System Including Same,” the contents of which are hereby incorporated by reference.

### TECHNICAL FIELD

The present disclosure relates to the technical field of fastening assemblies and, more particularly, to a fastening assembly, and a part in preassembly and a fastening system including same.

### BACKGROUND

A fastening assembly with a tolerance compensating function can compensate for tolerances caused by manufacturing and mounting operation while fastening two components. The fastening assembly typically comprises a threaded fastening element, via which the two components are fastened to each other.

### SUMMARY

The present disclosure relates generally to a fastening assembly, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a structural perspective view of a fastening system according to an embodiment of the present disclosure from one perspective.

FIG. 1B is a structural perspective view of the fastening system shown in FIG. 1A from another perspective.

FIG. 1C is an exploded view of the fastening system shown in FIG. 1A.

FIG. 2A is a structural perspective view of a fastening assembly in FIG. 1A.

FIG. 2B is a right elevation view of the fastening assembly shown in FIG. 2A.

FIG. 2C is an exploded view of the fastening assembly shown in FIG. 2A from one perspective.

FIG. 2D is an exploded view of the fastening assembly shown in FIG. 2A from another perspective.

FIG. 2E is a cross-sectional view, taken along line A-A, of the fastening assembly shown in FIG. 2B.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a fastening assembly, which is configured to securely connect a first component (e.g., a door handle module of a vehicle) to a second component (e.g., a door of the vehicle) via bolt, and the fastening assembly also has a tolerance compensating function and thus can compensate for tolerances caused by the manufacturing and assembly of components. The present disclosure further provides a fastening system comprising a fastening assembly described above.

First aspect of the present disclosure provides a fastening assembly for fastening a first component to a second component, the fastening assembly has an axis, and the fastening assembly comprising: a compensation element, a bolt and a washer. The compensation element has a receiving channel running through the compensation element in an axial direction, and the compensation element can rotate about the axis so as to be connected to the first component. The bolt has a shank and a limiting portion, the limiting portion protrudes outwardly from an outer peripheral surface of the shank and is received by the receiving channel of the compensation element, and the shank of the bolt extends out of the compensation element from the receiving channel to securely connect to the second component. The washer is received by the receiving channel, and the washer abuts against the limiting portion of the bolt to prevent the bolt from moving in the axial direction, wherein the washer is connected to the compensation element in such a way that the washer can rotate together with the compensation element.

According to the first aspect, the bolt and the washer are made of metal materials, and the compensation element is made of a plastic material.

According to the first aspect, the compensation element is provided with a limiting flange at one end, the limiting flange protrudes inwardly in a radial direction, and the washer is clamped between the limiting flange and the limiting portion of the bolt.

According to the first aspect, the washer and the compensation element are connected to each other in a form-fit manner.

According to the first aspect, the washer is provided with at least one notch, the compensation element is provided with at least one tab on the inner wall, and the at least one notch receives the at least one tab.

According to the first aspect, the compensation element comprises a first stop structure and a second stop structure respectively arranged at first end and second end, the first stop structure and the second stop structure is configured such that the compensation element is capable of being inserted into a mounting hole of the first component and preventing the compensation element from escaping from the mounting hole of the first component so as to pre-assemble the fastening assembly on the first component.

According to the first aspect, the compensation element is provided with a spiral groove on the outer surface, one of the first stop structure and the second stop structure comprises a stop block arranged at end of the spiral groove, and the other of the first stop structure and the second stop structure comprises a deflectable stop arm, the deflectable stop arm protrudes from the outer surface of the compensation element in a non-deflected state.

According to the first aspect, the fastening assembly further comprises a retaining element, the retaining element is located in the receiving channel and connected to an inner wall of the compensation element, and the retaining element is configured to elastically abut against the bolt so as to limit a position of the bolt in the axial direction and allow displacement of the bolt in a radial direction.

According to the first aspect, the compensation element comprises a first compensation section and a second compensation section, the first compensation section and the second compensation section are arranged in the axial direction and removably connected together, and the limiting flange is arranged on the first compensation section, the retaining element is connected to an inner wall of the second compensation section.

According to the first aspect, the retaining element comprises a plurality of elastic arms arranged at intervals around the axis, wherein each of the elastic arms comprises a connecting end and a free end, the connecting end is connected to the inner wall of the compensation element, and the free end is close to the bolt; and each of the elastic arms extends in a curved manner from the connecting end to the free end.

Second aspect of the present disclosure provides a part in preassembly, comprises: a first component and the fastening assembly according to any one of the above-mentioned first aspect, wherein the compensation element of the fastening assembly can rotate about an axis so as to be connected to the first component.

According to the second aspect, the first component is provided with a mounting hole, the first component comprises a protrusion arranged in the mounting hole, and an outer surface of the compensation element is provided with a spiral groove, the protrusion of the first component is engaged within the spiral groove of the compensation element and can be slid therein to connect the fastening assembly to the first component in a spiral manner.

Third aspect of the present disclosure provides a fastening system, comprises: a first component, a second component and the fastening assembly according to any one of the above mentioned first aspect, wherein the compensation element of the fastening assembly is capable of rotating about an axis so as to be connected to the first component, and the shank of the bolt of the fastening assembly is capable of passing through the second component so as to be securely connected to the second component.

According to the third aspect, the first component is provided with a mounting hole, the first component comprises a protrusion arranged in the mounting hole, and the compensation element is provided with a spiral groove on outer surface, wherein the protrusion of the first component is engaged within the spiral groove of the compensation element and can be slid therein to connect the fastening assembly to the first component in a spiral manner.

Other objects and advantages of the present disclosure will become apparent from the following description taken in conjunction with the accompanying drawings, which may facilitate to provide a thorough understanding of the present disclosure.

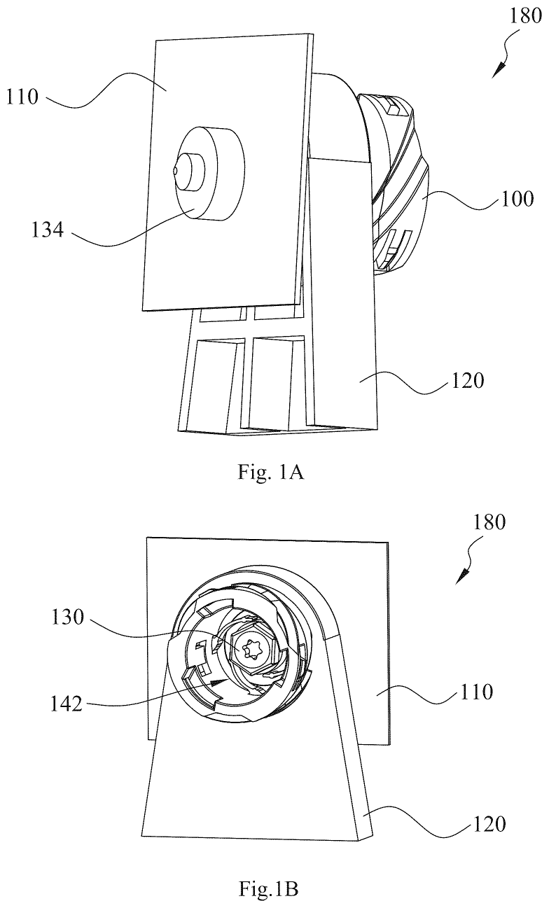

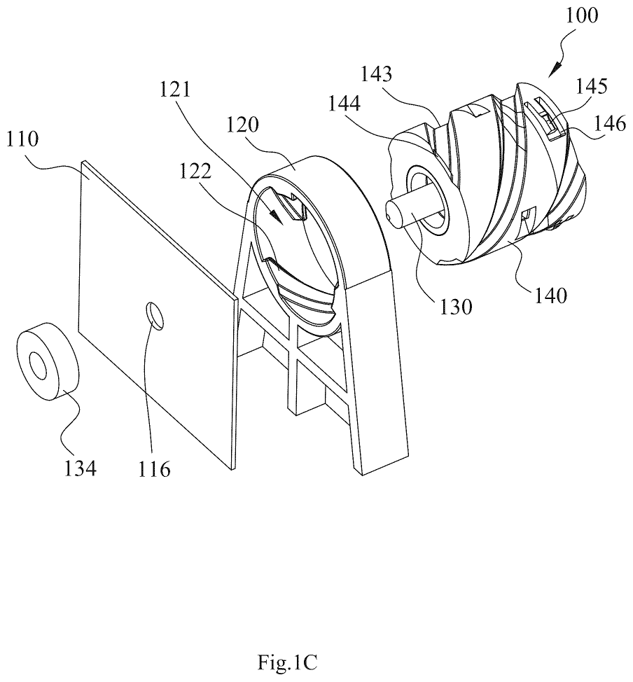

FIGS. 1A-1C show the general structure of a fastening system 180 including a fastening assembly 100 according to an embodiment of the present disclosure. FIG. 1A shows a structural perspective view of the fastening system 180 including the fastening assembly 100 according to an embodiment of the present disclosure from a front-to-rear perspective, FIG. 1B shows a structural perspective view of the fastening system 180 from a rear-to-front perspective, and FIG. 1C is an exploded view of the fastening system 180 in FIG. 1A.

As shown in FIGS. 1A-1C, the fastening system 180 includes a fastening assembly 100, a first component 120, and a second component 110; and the fastening assembly 100 is configured to fasten the first component 120 to the second component 110 and compensate for tolerances in various directions caused by manufacturing and/or assembly. In some embodiments, the first component 120 is, for example, a door handle module of a vehicle, and the second component 110 is, for example, a door of the vehicle. In order to show the fastening system 180 according to the present disclosure more clearly, simplified structures of the first component 120 and the second component 110 are shown.

Before being fastened to the second component 110, the fastening assembly 100 may be pre-assembled on the first component 120 to form a part in preassembly, thereby facilitating a manufacturer of the first component 120 to directly provide, to an end user, an assembled part that can be used for final assembly. When the first component 120 is a door handle module of a vehicle, a manufacturer of the door handle module may first assemble the fastening assembly 100 on the door handle module and then sell same to a vehicle manufacturer. In this way, the vehicle manufacturer can obtain an assembled part from supplier and then perform final assembly, facilitating the management of production and the optimal configuration of various resources. As will be described in detail below, the fastening assembly 100 pre-assembled on the first component 120 is not prone to escaping from the first component 120, thus facilitating the transportation and storage of the part in preassembly formed by the first component 120 and the fastening assembly 100 and the mounting of the part in preassembly at a final assembly position.

With continued reference to FIGS. 1A-1C, the fastening assembly 100 includes a compensation element 140. The compensation element 140 is substantially cylindrical in shape, the fastening assembly 100 and the compensation element 140 have a common axis i, and the compensation element 140 can rotate about the axis i. The compensation element 140 has a receiving channel 142 running through the compensation element in an axial direction. An outer surface of the compensation element 140 can engage with a mounting hole 121 of the first component 120 such that, as the compensation element 140 rotates, the compensation element 140 can engage with the first component 120 in a spiral manner, thereby securely connecting the fastening assembly 100 to the first component 120. In this embodiment, an outer diameter of the outer surface of the compensation element 140 is substantially the same as a diameter of the mounting hole 121. The compensation element 140 provided with at least one spiral groove 143 on outer surface thereof, each spiral groove 143 extending in a spiral manner about the axis i of the compensation element 140 on the outer surface of the compensation element 140, for example extending from a left end to a right end of the compensation element 140. A hole wall of the mounting hole 121 of the first component 120 is respectively provided with at least one protrusion 122. Each protrusion 122 can be engaged within a respective spiral groove 143 and slid therein, such that the compensation element 140 can engage with the first component 120 in a spiral manner, and move in the axial direction in the mounting hole 121 of the first component 120. In this way, the fastening assembly 100 can compensate for tolerances in the axial direction during a fastening operation for connecting the fastening assembly 100 to the second component 110. It will be appreciated by those skilled in the art that in other embodiments, the positions of the spiral groove and the protrusion may be inverted, i.e. the spiral groove is provided in the mounting hole 121 of the first component 120, and the protrusion is provided on the outer surface of the compensation element 140.

The compensation element 140 further includes a first stop structure and a second stop structure. The first stop structure and the second stop structure are arranged at two axial ends of the compensation element 140, and are configured such that the compensation element 140 can be inserted into the mounting hole 121 of the first component 120, and the compensation element 140 can be blocked from escaping from the mounting hole 121 of the first component 120.

In the illustrated embodiment, the first stop structure includes a stop block 144 arranged at a front end of the spiral groove 143. The stop block 144 is located in the spiral groove 143, that is, in a travel path of the protrusion 122 of the first component 120 when the protrusion travels in the spiral groove 143, radially protrudes from the bottom of the spiral groove 143, and thus can block the protrusion 122 of the first component 120 from moving out of the spiral groove 143.

The second stop structure includes a stop arm 145 arranged at a rear end of the compensation element 140. The stop arm 145 is substantially in the shape of a cantilever such that the stop arm 145 can be deflected. Specifically, the compensation element 140 has at least one window 146 on the rear end thereof, the window 146 running through a cylindrical wall of the compensation element 140. Each stop arm 145 has one end connected to an edge of the window 146 and the other end suspended such that the stop arm 145 has elasticity and can be deflected toward the receiving channel 142. Under non-deflected state, the stop arm 145 protrudes beyond the outer surface of the compensation element 140, to block the compensation element 140 from escaping from the mounting hole 121 of the first component 120. When the stop arm 145 is subjected to a pressure on an outer side thereof (such as a pressure applied by the hole wall of the mounting hole 121 of the first component 120, or the protrusion 122, or an operator's hand, or a mounting tool), the stop arm 145 can be pivoted about its connecting point and biased toward the receiving channel 142, so as no longer to block the compensation element 140 from inserting into the mounting hole 121 of the first component 120. The stop arm 145 extends substantially in a circumferential direction, thus having a longer effective blocking length.

In the illustrated embodiment, the first stop structure includes a stop block arranged in the spiral groove, and the second stop structure includes a deflectable stop arm, but in some other embodiments, the first stop structure and the second stop structure may be formed in an inverted manner. The number of first stop structures and the number of second stop structures each may be set to one or more. When there is more than one spiral groove 143, one first stop structure may be arranged at an end of each spiral groove 143, or first stop structures may be arranged only at ends of some spiral grooves 143. When there is more than one second stop structure, the second stop structures are uniformly arranged around the axis i on the cylindrical wall of the compensation element 140.

The fastening assembly 100 further includes a bolt 130 and a nut 134. In the present disclosure, the bolt 130 is arranged in the receiving channel 142 of the compensation element 140, and an end of the bolt 130 passes out of a front end of the compensation element 140. The end of the bolt 130 can pass through a connection hole 116 in the second component 110 and engage with the nut 134 to securely connect the fastening assembly 100 to the second component 110. In the present disclosure, the size of the receiving channel 142 is set to be larger than the size of the bolt 130 such that the position of the bolt 130 in a radial plane in the receiving channel 142 can be adjusted, and the bolt 130 thus can compensate for tolerances in the radial plane when securely connecting the fastening assembly 100 to the second component 110. The radial plane here refers to a plane perpendicular to the axis i. This will be explained in more detail later.

In this way, the fastening assembly 100 can connect the first component 120 and the second component 110 together and can compensate for tolerances in each direction during the connection.

An operation method for pre-assembling the fastening assembly 100 to the first component 120 will be described in detail below. During the pre-assembly operation:

1. The right end of the compensation element 140 of the fastening assembly 100 is aligned with the mounting hole 121 of the first component 120, the spiral groove 143 of the compensation element 140 is aligned with the protrusion 122 of the first component 120, the protrusion 122 is inserted into the spiral groove 143, and the stop arm 145 is deflected inwardly due to pressure from the hole wall of the mounting hole 121, thereby not affecting the insertion of the compensation element 140 into the mounting hole 121 and the rightward movement in the mounting hole 121.

2. Under the guidance of the protrusion 122 and the spiral groove 143, the compensation element 140 travels toward the right side while rotating. As the compensation element travels toward the right side, when the stop arm 145 is exposed out of the mounting hole 121 from the right side of the mounting hole 121, the stop arm 145 springs back outwardly.

In this way, after the compensation element 140 is pre-assembled to the first component 120, when the compensation element 140 moves toward the right side relative to the first component 120 to a first limit position, the stop block 144 arranged at the left end of the compensation element 140 can abut against the protrusion 122 of the first component 120, so as to prevent the compensation element 140 from escaping from the mounting hole 121 of the first component 120. When the compensation element 140 moves toward the left side relative to the first component 120 to a second limit position, the stop arm 145 arranged at the right end of the compensation element 140 can abut against the outer side of the mounting hole 121 of the first component 120, so as to prevent the compensation element 140 from escaping from the mounting hole 121 of the first component 120.

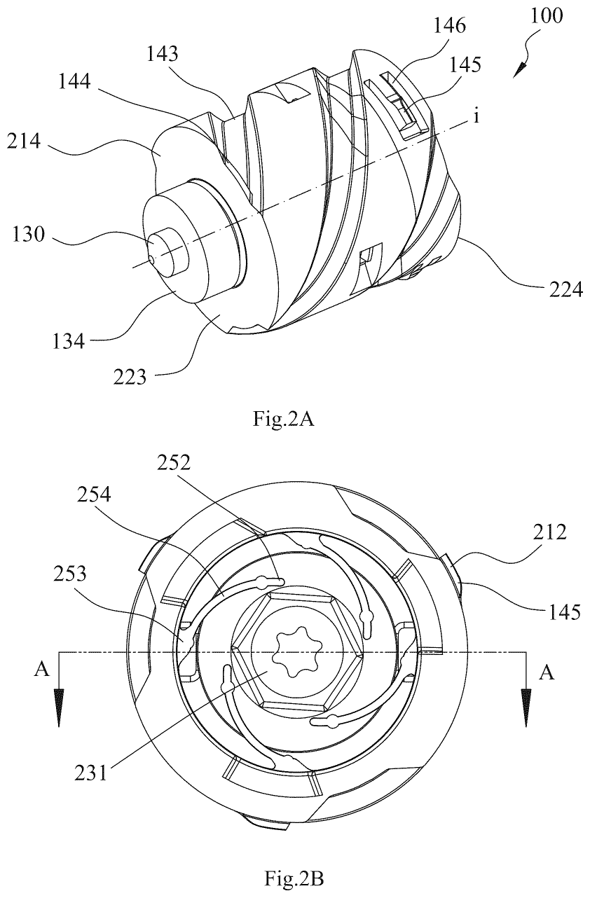

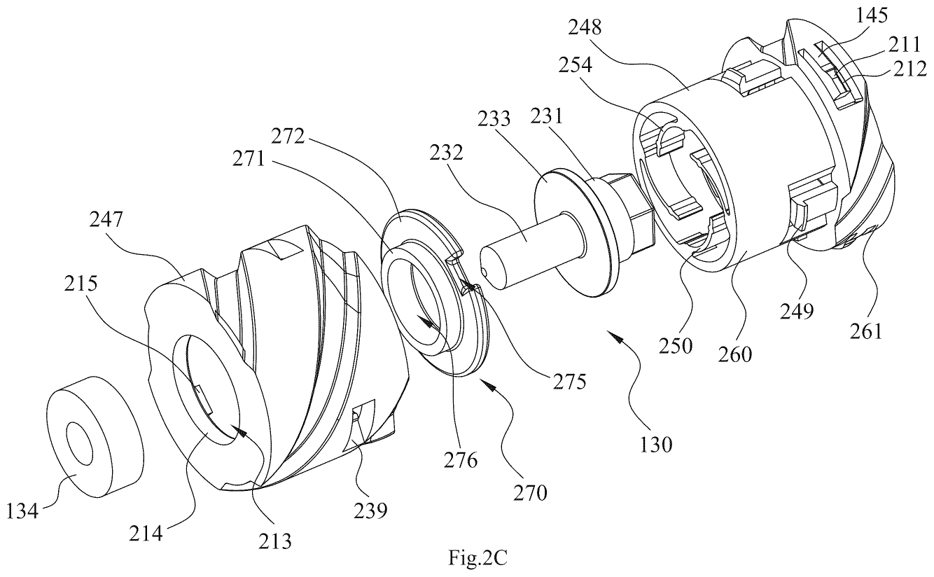

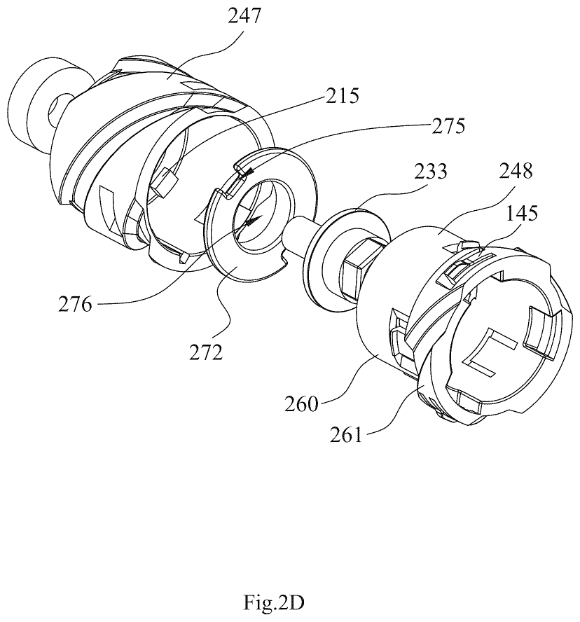

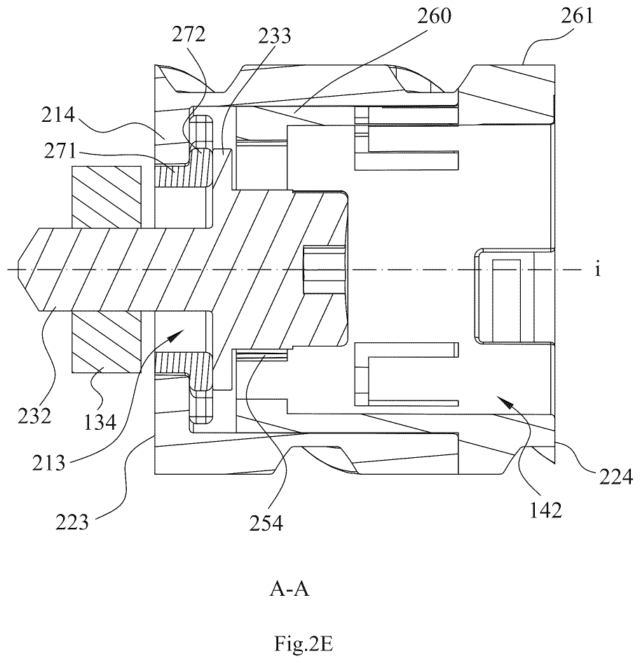

FIGS. 2A-2E show a more detailed structure of the fastening assembly 100. FIG. 2A shows a structural perspective view of the fastening assembly 100 from a front-to-rear perspective, FIG. 2B shows a right elevation view of the fastening assembly 100 shown in FIG. 2A, FIG. 2C shows an exploded view of the fastening assembly 100 from a front-to-rear perspective, FIG. 2D shows an exploded view of the fastening assembly 100 from a rear-to-front perspective, and FIG. 2E shows a cross-sectional view, taken along line A-A, of the fastening assembly 100 shown in FIG. 2B. As shown in FIGS. 2A-2E, the compensation element 140 includes a first compensation section 247 and a second compensation section 248. The first compensation section 247 and the second compensation section 248 are arranged in the axial direction and are removably connected to each other. In this embodiment, the first compensation section 247 is provided with snap windows 239 at intervals in the circumferential direction, and the second compensation section 248 is provided with snap arms 249 at corresponding positions in the circumferential direction. The snap arms 249 are snap-fit connected to the corresponding snap windows 239, to removably connect the first compensation section 247 to the second compensation section 248. In other embodiments, the first compensation section 247 and the second compensation section 248 may also be removably connected to each other via any other structure.

The left end 223 of the compensation element 140 is formed by the first compensation section 247, and the right end 224 of the compensation element 140 is formed by the second compensation section 248. The stop block 144 of the first stop structure is arranged in the spiral groove 143 of the first compensation section 247. The second compensation section 248 includes a cylindrical portion 260 and a seat portion 261. An outer diameter of the cylindrical portion 260 is smaller than an outer diameter of the seat portion 261, so that the cylindrical portion 260 can be inserted into the first compensation section 247, and the seat portion 261 abuts against a rear end face of the first compensation section 247. The spiral groove 143 extends continuously on outer surfaces of the first compensation section 247 and the seat portion 261 of the second compensation section 248. Moreover, the deflectable stop arm 145 of the second stop structure is arranged on a wall of the seat portion 261 of the second compensation section 248. As a more specific example, the stop arm 145 includes a driving portion 211 and a stop portion 212. The stop portion 212 protrudes from the outer surface of the compensation element 140 to block the compensation element 140 from escaping from the first component 120. The driving portion 211 is located on a rear side of the stop portion 212, and in a front-to-rear direction, the driving portion 211 is formed by extending obliquely inwardly from the most protruding portion of the stop portion 212.

In this way, when the right end 224 of the compensation element 140 is inserted into the mounting hole 121 of the first component 120, the driving portion 211 first enters the mounting hole 121, and as the compensation element 140 continues to move into the mounting hole 121, the hole wall of the mounting hole 121 squeezes an inclined face of the driving portion 211, thereby providing a pressure that makes the stop arm 145 deflect inwardly. After the stop arm 145 moves away from the hole wall of the mounting hole 121, the stop arm 145 returns to the non-deflected state to prevent the compensation element 140 from escaping from the mounting hole 121.

The left end 223 of the compensation element 140 is provided with a limiting flange 214. In this embodiment, the limiting flange 214 is arranged at an end of the first compensation section 247, and the limiting flange 214 protrudes radially inwardly such that the receiving channel 142 becomes smaller at the limiting flange 214. In this embodiment, the receiving channel 142 forms a through hole 213 in the limiting flange 214, the through hole 213 having a smaller diameter than the size of the receiving channel 142. In this way, the limiting flange 214 does not prevent the end of the bolt 130 from passing out of the compensation element 140 for connection with the second component 110, but blocks the bolt 130 as a whole from escaping from the receiving channel 142 of the compensation element 140.

The fastening assembly 100 further includes a retaining element 250. The retaining element 250 is configured to be capable of resisting, when the fastening assembly 100 does not fasten the first component 120 to the second component 110 (for example, during transportation and storage of the part in preassembly formed by the fastening assembly 100 and the first component 120, and during movement and alignment before the fastening assembly 100 and the first component 120 are fastened to the second component 110), a force that acts on the bolt 130 to make the bolt shake, the gravity, etc., such that the bolt 130 is retained substantially centrally in the receiving channel 142. This reduces or inhibits the shaking of the bolt 130, and causes the bolt 130 to be at or near a theoretical position, so as to facilitate quick fastening of the fastening assembly 100 to the second component 110 during subsequent fastening. During the process of the fastening assembly 100 fastening the first component 120 to the second component 110, the retaining element 250 allows the bolt 130 to be displaced in the radial plane relative to the compensation element 140 to compensate for tolerances in the radial plane. Specifically, the retaining element 250 has elasticity such that the retaining element 250 can elastically abut against the bolt 130, to limit the position of the bolt 130 in the axial direction, and allow the bolt 130 to be displaced in the radial plane. The retaining element 250 is located in the receiving channel 142 and is connected to a front end of an inner wall of the second compensation section 248.

The bolt 130 has a shank 232, a limiting portion 233 and a head 231. In the axial direction, the head 231 and the shank 232 are located at two ends of the bolt 130, respectively, and the limiting portion 233 is located between the head 231 and the shank 232. The limiting portion 233 has a larger outer diameter than the head 231 and the shank 232, that is, the limiting portion 233 protrudes radially outwardly relative to the shank 232 and the head 231, so that the limiting portion 233 can limit its position in cooperation with the retaining element 250 and the limiting flange 214, to limit the position of the bolt 130 in the axial direction. In some embodiments, the limiting portion 233 is in the shape of a flange, which protrudes radially outwardly and forms a substantially annular structure, and the retaining element 250 elastically abuts against a rear surface of the limiting portion 233. The shank 232 has an external thread, and a front end of the shank can extend from the through hole 213 to the outside of the compensation element 140, such that the external thread of the shank 232 can engage with the nut 134, thereby fastening the fastening assembly 100 to the second component 110. In some embodiments, a rear end of the head 231 is hexagonal shaped for engagement with a driving tool (not shown) to drive the bolt 130 to rotate. Moreover, a portion of the head 231 near the limiting portion 233 is configured to cooperate with the retaining element 250 to allow the bolt 130 to move in the radial plane. It will be appreciated by those skilled in the art that an appropriate size of the shank 232 may be set according to the size of the connection hole 116 of the second component 110. Moreover, an appropriate size of the head 231 may be set according to the specific shape and structure of the retaining element 250. The outer diameter of the limiting portion 233 is then made larger than the outer diameters of the head 231 and the shank 232. In some embodiments, it is also possible that no head 231 is provided, depending on the specific structure. Instead, the retaining element 250 cooperates with the limiting portion 233.

More specifically, in this embodiment, the retaining element 250 includes a plurality of elastic arms 254 arranged at intervals around the axis i, each elastic arm 254 including a connecting end 253 and a free end 252. The connecting end 253 is connected to the inner wall of the second compensation section 248, and the free end 252 is close to the bolt 130. Moreover, each of the elastic arms 254 extends in a curved manner from the connecting end 253 to the free end 252. The free ends 252 of the plurality of elastic arms 254 are arranged around the bolt 130. An included angle between the free end 252 of each elastic arm 254 and a surface of the head 231 of the bolt 130 is less than 90 degrees, for example, not greater than 45°, so that an elastic force applied by the elastic arm 254 to the head 231 via the free end 252 is relatively gentle and changes relatively gently. Each elastic arm 254 is made of an elastic plastic sheet material, and has a width direction extending substantially in the axial direction, and each elastic arm 254 has a certain thickness. By designing the material, the thickness dimension, etc. of the elastic arm 254, the elastic arm 254 can have sufficient elasticity in the radial plane. It will be appreciated by those skilled in the art that although in the illustrated embodiment, the elastic arm 254 extends in a curved manner from the connecting end 253 to the free end 252, in some other embodiments, the elastic arm may extend only partially in a curved manner, or the elastic arm may extend in a straight line, or the elastic arm may extend partially in a straight line and partially in a curved manner.

In this way, the elastic arm 254 of the retaining element 250 can elastically abut against the head 231 of the bolt 130, so that the retaining element 250 can retain the bolt 130 in a preset position (approximately centered position) in the receiving channel 142. The retaining element 250 also allows the bolt 130 to be displaced in the radial plane when there is a tolerance.

The fastening assembly 100 further includes a washer 270. The washer 270 is clamped approximately axially between the limiting flange 214 of the compensation element 140 and the limiting portion 233 of the bolt 130. The washer 270 includes a sleeve portion 271 and a flange portion 272. The flange portion 272 is located on a rear side of the sleeve portion 271 in the axial direction, and the flange portion 272 is formed by protruding radially outwardly from a rear edge of the sleeve portion 271. An outer diameter of the sleeve portion 271 is approximately equal to the diameter of the through hole 213 in the limiting flange 214 such that the sleeve portion 271 can be barely inserted into the through hole 213. A front surface of the flange portion 272 abuts against the limiting flange 214 to prevent the flange portion 272 from escaping from the front side of the compensation element 140. The limiting portion 233 of the bolt 130 abuts against a rear surface of the flange portion 272 such that the washer 270 and the retaining element 250 together retain the bolt 130 in place in the axial direction. The washer 270 has a channel 276 running through the washer in the axial direction. The channel 276 is dimensioned to be larger than the outer diameter of the shank 232 of the bolt 130 such that when the limiting portion 233 of the bolt 130 abuts against the rear surface of the flange portion 272 of the washer 270, the shank 232 of the bolt 130 can pass out of the channel 276 to the outside of the compensation element 140, leaving room for the bolt 130 to move in the radial plane.

In the present disclosure, the washer 270 and the compensation element 140 are arranged to be connected in such a way that the washer 270 and the compensation element 140 rotate together. In some embodiments, the washer 270 and the compensation element 140 are connected to each other in a form-fit manner. In other embodiments, the washer 270 and the compensation element 140 may be fixedly connected together in other manners so long as they can rotate together. As a specific embodiment, the flange portion 272 of the washer 270 is provided with at least one notch 275. The notch 275 is formed by radially recessing from an outer edge of the flange portion 272. Correspondingly, the compensation element 140 is provided with at least one tab 215 on the inner wall. The tab 215 is arranged on the inner wall near the limiting flange 214, and is formed by radially protruding from the inner wall. The notch 275 can receive the tab 215 to connect the washer 270 to the compensation element 140 such that the washer 270 and the compensation element 140 can rotate together. In this embodiment, the number of notches 275 is set to two, and the two notches 275 are symmetrically arranged along the axis i. Correspondingly, the number of tabs 215 is also set to two. It will be appreciated by those skilled in the art that although in this embodiment the notch and tab are configured to have the same shape and size, in other embodiments, the notch 275 and the tab 215 may also be provided in other mating structures or numbers, and are not necessary to have the same shape and size, as long as relative rotation between the washer 270 and the compensation element 140 can be prevented so that they can rotate together.

Therefore, in further connection with FIG. 2E, the fastening assembly 100 is assembled by means of the following method. First, the washer 270 is inserted into the first compensation section 147 of the compensation element 140, the notch 275 of the washer 270 receives the tab 215 of the compensation element 140, and the sleeve portion 271 of the washer 270 is inserted into the through hole 213 of the limiting flange 214. The bolt 130 is then inserted into the channel 276 of the washer 270, the shank 232 of the bolt 130 passes out of the channel 276, and the limiting portion 233 of the bolt 130 abuts against a right side surface of the washer 270. Finally, the second compensation section 248 of the compensation element 140 is connected to the first compensation section 247, the cylindrical portion 260 of the second compensation section 248 is inserted into the first compensation section 247, the front side of the elastic arm 254 of the retaining element 250 abuts against a right side surface of the limiting portion 233 of the bolt 130, and the free end 252 elastically abuts against the head 231 of the bolt 130, thereby obtaining the assembled fastening assembly 100.

In the present disclosure, the bolt 130 and the washer 270 are made of metal materials, and the compensation element 140 is made of a plastic material. In this way, when the fastening assembly 100 fastens the first component 120 to the second component 110, the washer 270 with high strength can directly withstand an axial fastening force of the bolt 130, so as to protect the compensation element 140 with low-strength, reduce the risk of plastic deformation, cracking, or other failures of the compensation element 140, and prolong the service life of the compensation element 140.

After the fastening assembly 100 has assembled the first component 120 with the second component 110, if the fastening system 180 is subjected to an axial force such as an external vibration or pulling, the compensation element 140 may rotate. The rotation of the compensation element 140 will cause the axial distance between the first component 120 and the second component 110 to change. When the first component 120 is a handle of a vehicle and the second component 110 is sheet metal of the vehicle, a change in the distance between the two causes the handle of the vehicle to shake.

The fastening assembly 100 of the present disclosure prevents rotation of the washer 270 by abutting the bolt 130 against the washer 270, thereby preventing rotation of the compensation element 140. Moreover, since the torque attenuation between the bolt 130 made of a metal material and the washer 270 made of a metal material is less than the torque attenuation between the washer 270 made of a metal material and the compensation element 140 made of a plastic material, so that it is less likely to cause the torque attenuation between the washer 270 and the compensation element 140 that rotate together.

The fastening assembly 100 of the present disclosure is connected to the first component 120 and the second component 110 to form the fastening system 180. The performance of the fastening system is tested in a simulated vehicle environment.

The fastening systems of Examples 1-5 and the fastening systems of Comparative Examples 1-5 were subjected to a temperature cycle torque attenuation test on the bolts thereof. The fastening systems were stored at a high temperature of 85° C. for 4 h, stored at a low temperature of −40° C. for 4 h, and then stored at room temperature for 12 h. Residual torque was measured, and the compensation element was subjected to an axial pull-out tensile test. The results are shown in Table 1. In the fastening systems of Examples 1-5, the washer and the compensation element have shapes designed in such a way that they can rotate together, and in the fastening system of Comparative Examples 1-5, the washer and the compensation element have shapes designed in such a way that they can rotate relative to each other.

TABLE 1
Torque attenuation test and tensile test results for temperature
cycles of Examples 1-5 and Comparative Examples 1-5

| | | | | Maximum |
|---|---|---|---|---|
| | | Residual | Residual | tensile force |
| | Tightening | torque | torque | N at room |
| No. | torque Nm | Nm | percentage | temperature |
| Example 1 | 5.00 | 4.01 | 80.20% | 2000 |
| Example 2 | 5.00 | 4.60 | 92.00% | 2000 |
| Example 3 | 5.00 | 4.70 | 94.00% | 1442 |
| Example 4 | 5.00 | 4.71 | 94.20% | 1500 |
| Example 5 | 5.00 | 4.67 | 93.40% | 1500 |
| Comparative | 5.00 | 1.16 | 23.28% | 1333 |
| Example 1 | | | | |
| Comparative | 5.00 | 1.42 | 28.48% | 1104 |
| Example 2 | | | | |
| Comparative | 5.00 | 1.11 | 22.14% | 1124 |
| Example 3 | | | | |
| Comparative | 5.00 | 0.93 | 18.62% | 1009 |
| Example 4 | | | | |
| Comparative | 5.00 | 1.11 | 22.12% | 1025 |
| Example 5 | | | | |

It can be seen that the torque attenuation of the fastening systems of Examples 1-5 of the present disclosure is small, the connection structures of the fastening systems are stable and reliable, and the maximum withstood tensile force is increased.

The fastening assembly of the present disclosure is connected to the first component by means of the outer surface of the compensation element and to the second component by means of the bolt, so that the first component and the second component can be connected together.

The fastening assembly of the present disclosure can compensate for manufacturing or assembly tolerances of the first component and the second component in the axial direction by means of the rotation of the compensation element, and compensate for the manufacturing or assembly tolerances of the first component and the second component in the radial plane by means of the relative displacement of the retaining element and the bolt in the radial plane, so that the fastening assembly is particularly suitable for use in secure connection environments with certain tolerances, for example, for use in assembling the handle of the vehicle to the sheet metal of the vehicle.

Moreover, in the fastening assembly of the present disclosure, the washer and the compensation element can rotate together by adding a limiting structure on the washer. The washer is then prevented from rotating by abutting the bolt against the washer, thereby preventing the compensation element from rotating. Moreover, since the torque attenuation between the bolt made of a metal material and the washer made of a metal material is less than the torque attenuation between the washer made of a metal material and the compensation element made of a plastic material, so that it is less likely to cause the torque attenuation between the washer and the compensation element that rotate together. Therefore, the first component connected by means of the compensation element is also less likely to shake relative to the second component, making the connecting structure more robust and reliable.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting. Therefore, the present disclosure in this specification may be used to solve other technical problems and may have other technical effects. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

What is claimed is:

1. A fastening assembly for fastening a first component to a second component, the fastening assembly having an axis, and the fastening assembly comprising:
a compensation element, the compensation element having a receiving channel running through the compensation element in an axial direction, and the compensation element being capable of rotating about the axis so as to be connected to the first component;
a bolt, the bolt having a shank and a limiting portion, the limiting portion protruding outwardly from an outer peripheral surface of the shank, the limiting portion of the bolt being received by the receiving channel of the compensation element, and the shank of the bolt extending out of the compensation element from the receiving channel and being configured to be securely connected to the second component; and
a washer, the washer being received by the receiving channel, and the washer abutting against the limiting portion of the bolt to prevent the bolt from moving in the axial direction,
wherein the washer is connected to the compensation element in such a way that the washer is capable of rotating together with the compensation element.

2. The fastening assembly according to claim 1, wherein the bolt and the washer are made of metal materials, and the compensation element is made of a plastic material.

3. The fastening assembly according to claim 2, wherein the compensation element is provided with a limiting flange arranged at one end, the limiting flange protrudes inwardly in a radial direction, and the washer is clamped between the limiting flange and the limiting portion of the bolt.

4. The fastening assembly according to claim 3, wherein the washer and the compensation element are connected to each other in a form-fit manner.

5. The fastening assembly according to claim 4, wherein the washer is provided with at least one notch, the compensation element is provided with at least one tab on the inner wall, and the at least one notch receives the at least one tab.

6. The fastening assembly according to claim 4, wherein the compensation element comprises a first stop structure and a second stop structure respectively arranged at first end and second end, the first stop structure and the second stop structure being configured such that the compensation element is capable of being inserted into a mounting hole of the first component and preventing the compensation element from escaping from the mounting hole of the first component so as to pre-assemble the fastening assembly on the first component.

7. The fastening assembly according to claim 6, wherein the compensation element is provided with a spiral groove on outer surface, one of the first stop structure and the second stop structure comprises a stop block arranged at end of the spiral groove, and the other of the first stop structure and the second stop structure comprises a deflectable stop arm, the deflectable stop arm protruding from the outer surface of the compensation element in a non-deflected state.

8. The fastening assembly according to claim 6, wherein the fastening assembly further comprises a retaining element, the retaining element being located in the receiving channel and connected to an inner wall of the compensation element, and the retaining element being configured to elastically abut against the bolt so as to limit a position of the bolt in the axial direction and allow displacement of the bolt in a radial direction.

9. The fastening assembly according to claim 8,
wherein the compensation element comprises a first compensation section and a second compensation section, the first compensation section and the second compensation section being arranged in the axial direction and removably connected together, and the limiting flange being arranged on the first compensation section, and
wherein the retaining element is connected to an inner wall of the second compensation section.

10. The fastening assembly according to claim 8,
wherein the retaining element comprises a plurality of elastic arms arranged at intervals around the axis, wherein each of the elastic arms comprises a connecting end and a free end, the connecting end being connected to the inner wall of the compensation element, and the free end being close to the bolt, and
wherein each of the elastic arms extends in a curved manner from the connecting end to the free end.

11. A part in preassembly, comprising:
a first component; and
a fastening assembly according to any one of claim 1,
wherein the compensation element of the fastening assembly is capable of rotating about an axis so as to be connected to the first component.

12. The part in preassembly according to claim 11,
wherein the first component is provided with a mounting hole, the first component comprises a protrusion arranged in the mounting hole, and an outer surface of the compensation element is provided with a spiral groove, and
wherein the protrusion of the first component is engaged within the spiral groove of the compensation element and can be slid therein to connect the fastening assembly to the first component in a spiral manner.

13. A fastening system, comprising:
a first component;
a second component; and
a fastening assembly according to any one of claim 1,
wherein the compensation element of the fastening assembly is capable of rotating about an axis so as to be connected to the first component, and
wherein the shank of the bolt of the fastening assembly is capable of passing through the second component so as to be securely connected to the second component.

14. The fastening system according to claim 13,
wherein the first component is provided with a mounting hole, the first component comprises a protrusion arranged in the mounting hole, and an the compensation element is provided with a spiral groove on outer surface, and
wherein the protrusion of the first component is engaged within the spiral groove of the compensation element and can be slid therein to connect the fastening assembly to the first component in a spiral manner.
